(19) United States
(12) Patent Application Publication
(10) Pub. No.: US 2009/0015930 A1
(43) Pub. Date: Jan. 15, 2009

(54) COLLIMATOR

(75) Inventors: Rifat A.M. Hikmet, Eindhoven (NL); Ties Van Bommel, Horst (NL); Peter Van De Witte, New Territories (HK); Reinhold Wimberger-Friedl, Veldhoven (NL); Dirk Burdinski, Essen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,316

(22) PCT Filed: Dec. 8, 2004
(86) PCT No.: PCT/IB2004/052708

§ 371 Date: Jun. 9, 2006

(30) Foreign Application Priority Data
Dec. 10, 2003 (GB) 0328588.9

(51) Int. Cl. G02B 27/30; B29D 11/00; B05D 1/04; G01T 1/00; G21F 3/00; B29C 35/08

(52) U.S. Cl. 359/641; 216/24; 427/458; 427/598; 250/515.1; 378/51

(57) ABSTRACT

A collimator panel comprises: a solid panel having a first face for receiving uncollimated radiation and a second opposite face for providing collimated radiation; and a plurality of elongate particles disposed in the panel and orientated to provide the collimating function. A method of manufacturing a collimator panel comprises the steps of: suspending a plurality of elongate particles in a liquid; applying an electric or magnetic field to the suspension to orientate the particles; and solidifying the liquid to fix the orientation of the particles, thereby forming a collimator panel. A method of manufacturing the elongate particles is also provided.

This invention relates to collimators. In particular, this invention relates to converging, diverging and parallel collimators for electromagnetic waves such as visible light or X-rays.

Collimators are employed in a variety of applications spanning a great many fields of technology. Typically, they are component parts of more complicated pieces of equipment. Broadly defined, a collimator is a device that limits the size and angle of spread of a beam of electromagnetic radiation in some way.

Collimators may be realised in a number of ways. Purely by way of example, two known collimators will now be briefly described.

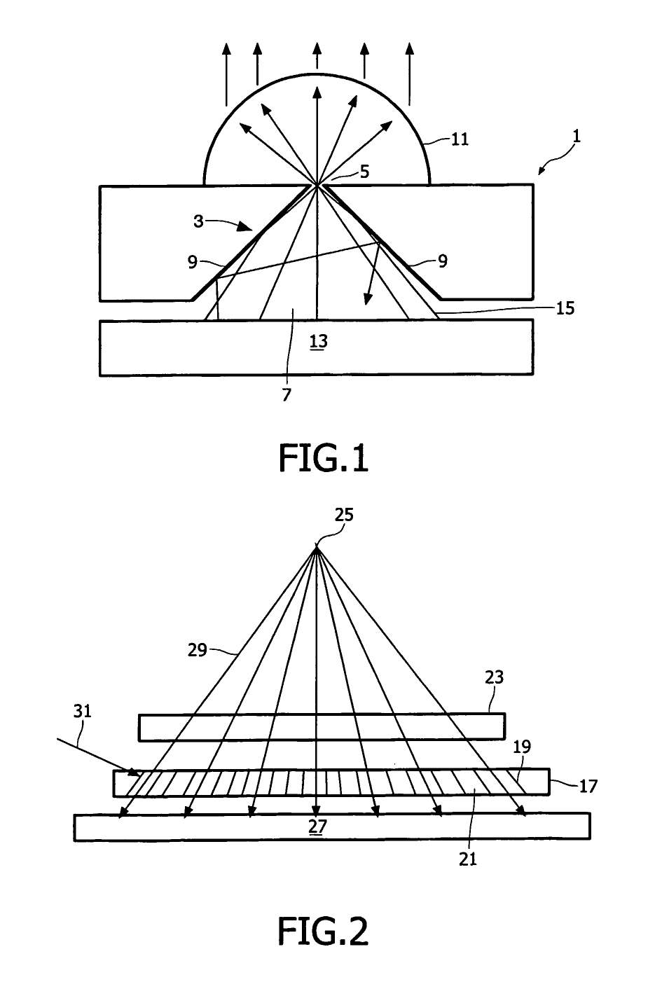

FIG. 1 shows a first known collimator 1 for use in collimating visible light. The collimator 1 is typically used in conjunction with a backlight to provide collimated backlighting for a transmissive liquid crystal display (LCD) device. Collimated backlighting is especially required where cholesteric colour filters are used. Collimated backlighting also helps to reduce the angular dependence of contrast associated with LCD devices.

The collimator 1 takes the form of an inverse pyramid structure 3 having a small opening 5 where the pyramid surface converges and having a large opening 7 at its base. The internal surface 9 of the structure 3 is coated with a highly reflective finish so that it reflects almost all light that is incident. A semi-spherical lens 11 is optionally positioned on top of the inverse pyramid structure 3 and centred about the small opening 5. A light source 13 is positioned adjacent the large opening 7 so that rays of light 15 propagate from the light source 13 and into the pyramid structure through the large opening 7. Rays of light 15 enter the pyramid structure at different angles and are reflected by the internal surface 9 until they eventually either pass through the small opening 5 or are reflected back through the large opening 7 towards the light source. The rays of light 15 that propagate through the small opening 5 diverge from the small opening 5 at an angle that depends on the angle of the internal surface 9. As shown in FIG. 1, refraction in the optional lens 11 causes collimated diverging rays of light to become collimated parallel rays of light.

The collimator described with reference to FIG. 1 provides a source of collimated visible light. However, it is inefficient because, as shown in FIG. 1, some rays of light 15 are reflected twice by the internal surface 9 and back out of the pyramid structure. Accordingly, there is a requirement for a more efficient collimator of visible light.

FIG. 2 shows a second known collimator 17 for use in collimating X-ray radiation. The collimator 17 of FIG. 2 is typically used in conjunction with X-ray detectors to minimise the contrast-reducing effects of scattered X-rays on images.

The collimator 17 takes the form of an array of lead foil strips 19 which are separated by wider strips of radiolucent material 21. The radiolucent material is typically an organic material such as a polymer.

In use, an object to be detected 23 and the collimator 17 are placed between a point X-ray source 25 and an X-ray detector 27. X-rays 29 propagating directly from the X-ray source 25 towards the detector 27 without having been reflected are transmitted by the collimator 17, as shown in FIG. 2. However, scattered X-rays 31 not propagating directly from the X-ray source 25 are absorbed by the collimator 17, also as shown in FIG. 2. In the collimator 17, the directly propagating X-rays 29 are transmitted by the radiolucent material, while the scattered X-rays 31 are absorbed by the lead foil.

The collimator described with reference to FIG. 2 improves the contrast of X-ray images. However, the collimator also has a detrimental effect on the quality of the image generated by the detector. In particular, the array of lead foil strips casts a shadow on the detector because it absorbs some of the X-rays that are propagating directly from the X-ray source, as well as the scattered X-rays. To overcome this detrimental effect, the collimator may be moved from left to right during detection so that the effects of the shadow are averaged across all regions of the detector. However, this requires expensive control equipment.

The X-ray collimator itself is also expensive to manufacture, since the manufacturing process consists of stacking alternate layers of lead and radiolucent material. The layers of lead are typically between 16 μm and 40 μm thick and they are arranged at a pitch of between 150 μm and 300 μm. Each layer must be individually handled and so defect rates are high. The X-ray collimator may alternatively be manufactured by moulding alternate layers of lead and radiolucent material in a micro-structured mould. However, it is very difficult to achieve sufficient aspect ratios for the layers of lead using moulding techniques. Accordingly, there is a requirement for an improved collimator of X-ray radiation.

According to a first aspect of the invention there is provided a collimator panel comprising: a solid panel having a first face for receiving uncollimated radiation and a second opposite face for providing collimated radiation; and a plurality of elongate particles disposed in the panel and orientated to provide the collimating function.

The solid panel is transparent to a form of electromagnetic radiation with which the collimator is to be used, while the elongate particles are not transparent to the electromagnetic radiation.

The longitudinal axes of the particles may be orientated in a parallel configuration. Such a collimator panel provides parallel collimated radiation. In this case, the longitudinal axes of the particles may be orientated perpendicular to the surface of the collimator panel, or else may be orientated at some other constant angle to the surface of the collimator panel.

The particles may for example, absorb visible light, and such a configuration provides an effective collimator of focused visible light. The particles may alternatively reflect visible light. In either case, the particles may also absorb or reflect light in the infrared range respectively.

The longitudinal axes of the particles may alternatively be orientated in a converging configuration. Depending on which side of the collimator panel the electromagnetic radiation is incident, the collimator panel will then function as either a converging or a diverging collimator.

The longitudinal axes of the particles preferably converge to a point at a predetermined distance from the collimator plate. Alternatively, the longitudinal axes of different groups of particles may converge to points at different distances from the collimator plate. For example, different groups of particles may be orientated at different angles to the normal of the collimator panel.

The surfaces of the particles may reflect visible light. Such a configuration provides an efficient collimator of unfocused visible light. In this case, the particles may be metallic particles such as aluminium particles or aluminium alloy particles, and the solid panel may be translucent.

Highly reflective particles obtained by deposition of dielectric multi-layers may be used, in which case almost no visible light is absorbed. Cholesteric liquid crystal particles which reflect a specific band of light may also be used. Such particles may be in the form of glassy molecules, linear polymers or cross-linked polymers.

The surfaces of the particles may absorb X-ray radiation. Such a configuration provides an effective collimator of X-ray radiation. In this case, the particles may be heavy-metal particles such as lead particles, lead alloy particles or tungsten particles, and the solid panel may be radiolucent.

The particles may comprise organic, preferably polymeric, particles filled with another material, such as a heavy metal. Such an arrangement may reduce the effective density of the particles and may help to achieve a homogeneous suspension of particles during manufacture of the collimator plate.

The ratio between thickness and length of the particles is preferably at least 1:10, and more preferably at least 1:100. Such a ratio provides a collimator that effectively collimates radiation without causing excessive attenuation of the radiation. The thickness of the particles is preferably in the range 5 nm to 1 μm, more preferably in the range 5 nm to 50 nm and the length of the particles is preferably in the range 1 μm to 100 μm, more preferably in the range 5 μm to 50 μm.

The solid panel may comprise a cured polymerisable liquid. The cured polymerisable liquid may comprise a cured (metha)acrylate, a cured epoxy, a cured vinylether monomer or a cured thiolene system. For example, the cured polymerisable liquid may comprise a cured polyethyleneglycol (400) diacrylate.

The solid panel may comprise an organic material having a solidifying temperature preferably above 40° C., and more preferably above 60° C. The organic material may be a polymer.

The invention also provides a display device, a backlight for a transmissive liquid crystal display device and an X-ray detector, each of which comprise one of the collimator panels described above.

The invention further provides an array of collimator panels comprising a plurality of the collimator panels described above. Each of the collimator panels, or structures, in the array may have different collimating properties arranged in a structured way.

According to a second aspect of the invention, there is provided a method of manufacturing a collimator panel, the method comprising the steps of: suspending a plurality of elongate particles in a liquid; applying an electric or magnetic field to the suspension to orientate the particles; and solidifying the liquid to fix the orientation of the particles, thereby forming a collimator panel.

The second aspect provides an effective method for manufacturing the first aspect of the invention, namely the collimator panel.

The method may further comprise the step of bringing the suspension between contoured surfaces prior to the step of applying an electric or magnetic field. In this case, the method may further comprise the step of flattening the manufactured collimator panel. This step is preferably carried out after the step of solidifying the liquid.

In this way, the orientation of the particles in the collimator panel may be accurately controlled. Specifically, the particle orientation is frozen while the suspension is held between contoured, or shaped, surfaces. The panel is then solidified, and then flattened to provide the desired particle orientation. Alterations in the form of the contoured surfaces give rise to accurately controllable changes in the orientation of the particles once the collimator panel has been flattened.

The method may further comprise the step of bringing the suspension between flat surfaces prior to the step of applying an electric or magnetic field.

The step of applying an electric or magnetic field may comprise applying an electric or magnetic field having parallel field lines. In this case, any required nonparallel orientation of the particles must be induced by other means, such as that described above.

Alternatively, the step of applying an electric or magnetic field may comprise applying an electric or magnetic field having nonparallel field lines. The nonparallel field lines then induce nonparallel orientation of the particles either alone or in combination with other means, such as that described above. When non-parallel field lines are used, it may be necessary to employ means for preventing migration of particles, for example, by using high viscosity liquids.

The step of applying the electric or magnetic field may be combined with the step of solidifying the liquid in a time or space resolved manner. For example, such a step may comprise applying an electric or magnetic field having parallel field lines to the entire or a specific region of the suspension of particles, and then solidifying only a part of the liquid to fix the particle orientation in a first local area. Next, the orientation of the suspension of particles with respect to the field lines may be changed and another part of the liquid solidified, thus fixing the particle orientation in a second local area. In this way, the particle orientation induced in the first and second local areas is different, and the step may be continued for each of a remaining number of local areas. Such a step allows a great degree of control of the independent orientation of the particles in different local areas.

An electric field may be applied using patterned electrodes in order to increase the concentration of particles in certain regions. In this way, super structures having large dimensions and a high aspect ratio may be produced based on smaller particles. For example, when an electric field is applied using an electrode having a ruled grating pattern, the particles from the areas having no adjacent electrode may be pulled into other areas having a higher field density. Thus super structures having some areas containing a high density of particles and other areas containing almost no particles may be produced. Thin and relatively short flakes may be used to produce areas with high metal loading that can be tens of microns long and several millimeters thick. Such arrangements may provide improved absorption of high-energy electromagnetic radiation such as X-rays.

Alternatively, the elongate particles may be homogeneously distributed.

The liquid is preferably a polymerisable liquid, and the step of solidifying the liquid comprises polymerising the liquid. In this case, the step of polymerising the liquid preferably comprises exposing the liquid to ultraviolet light to initiate a polymerisation reaction. Polymerisation may alternatively be thermally initiated. The polymerisable liquid preferably comprises a (metha)acrylate, an epoxy, a vinylether monomer or a thiolene system. For example, it may comprise polyethyleneglycol (400) diacrylate.

The use of multifunctional monomers leads to the formation of cross-linked polymer networks. However the monomers may also be monofunctional. In this case, a linear polymer is obtained.

The liquid is alternatively a heated organic material having a solidification temperature (glass transition temperature or melting point) above 40° C., preferably above 60° C., and the step of solidifying the liquid comprises cooling the liquid to ambient temperature.

The liquid preferably has sufficient viscosity to maintain an evenly distributed suspension of elongate particles without preventing the elongate particles from becoming aligned with the electric or magnetic field.

According to a third aspect of the invention, there is provided a method of manufacturing elongate particles for suspending in panels, the method comprising the steps of: depositing a patterned layer of negative etch resist material on a layer of elongate particle material, patterned areas representing a required shape and size of a plurality of elongate particles; and etching areas of the layer of elongate particle material not covered by the negative etch resist material, thereby leaving elongate particles.

The third aspect provides an effective method of producing precision elongate particles for use in the second aspect. The layer of elongate particle material may, for example, be lead or aluminium.

Preferably, the layer of elongate particle material is disposed on a substrate coated with a release layer, and the method preferably further comprises, after the step of etching, the step of releasing the elongate particles from the substrate. The step of releasing the elongate particles from the substrate preferably comprises dissolving the release layer in a solvent.

The method preferably further comprises, after the step of etching, the step of removing the negative etch resist material from the elongate particle material. This removes any contamination from the elongate particles.

The patterned layer of negative etch resist material is preferably deposited by offset printing, microcontact printing or inkjet printing. Microcontact printing is particularly advantageous.

According to a fourth aspect of the invention, there is provided a method of manufacturing elongate particles for suspending in panels, the method comprising the steps of: depositing a patterned layer of positive etch resist material on a layer of elongate particle material, unpatterned areas representing a required shape and size of a plurality of elongate particles; processing the unpatterned areas to make them more etch resistant than the patterned areas; and removing the positive etch resist material and etching areas of the layer of elongate particle material that were covered by the positive etch resist material, thereby leaving elongate particles.

The fourth aspect provides an alternative method of producing precision elongate particles for use in the second aspect. The layer of elongate particle material may, for example, be lead or aluminium. The step of processing the unpatterned areas of the layer of elongate particle material may involve applying a material having a very high etch resistance to so far unmodified areas, for example, by deposition via self-assembly from solution.

The layer of elongate particle material is preferably disposed on a substrate coated with a release layer, and the method preferably further comprises, after the step of etching, the step of releasing the elongate particles from the substrate. The step of releasing the elongate particles from the substrate may comprise dissolving the release layer in a solvent.

The patterned layer of positive etch resist material is preferably deposited by offset printing, microcontact printing or inkjet printing. Microcontact printing is particularly advantageous.

For a better understanding of the above features and advantages of the invention, embodiments will now be described, purely by way of example, with reference to the accompanying drawings in which:

FIG. 1 shows in schematic form a first known collimator for use in collimating visible light, together with a light source and a lens;

FIG. 2 shows in schematic form a second known collimator for use in collimating X-ray radiation, together with an X-ray source, an object to be imaged and an X-ray detector;

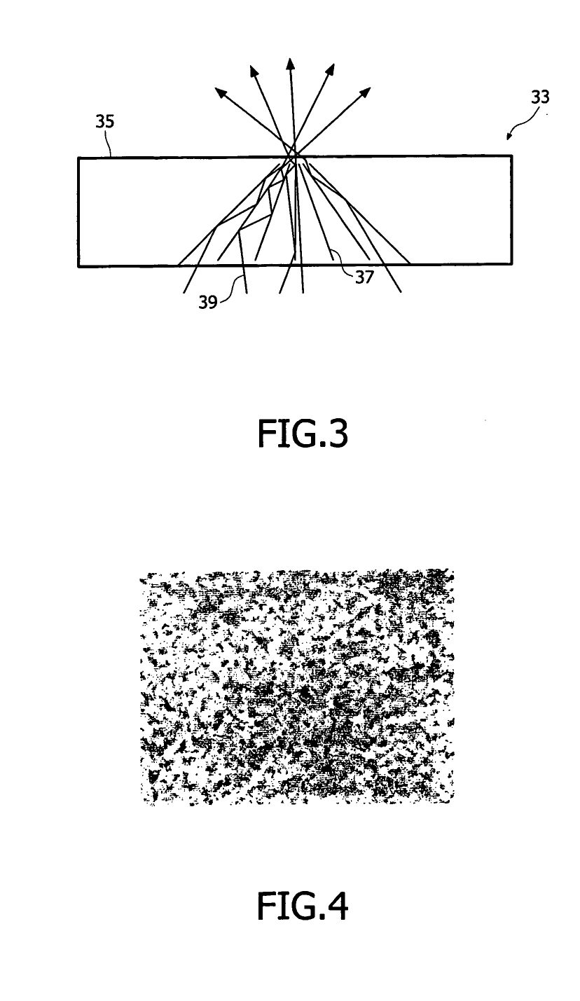

FIG. 3 shows in schematic form a first collimator panel according to the invention for use in collimating visible light;

FIG. 4 is a microscopic image of the first collimator panel shown in FIG. 3;

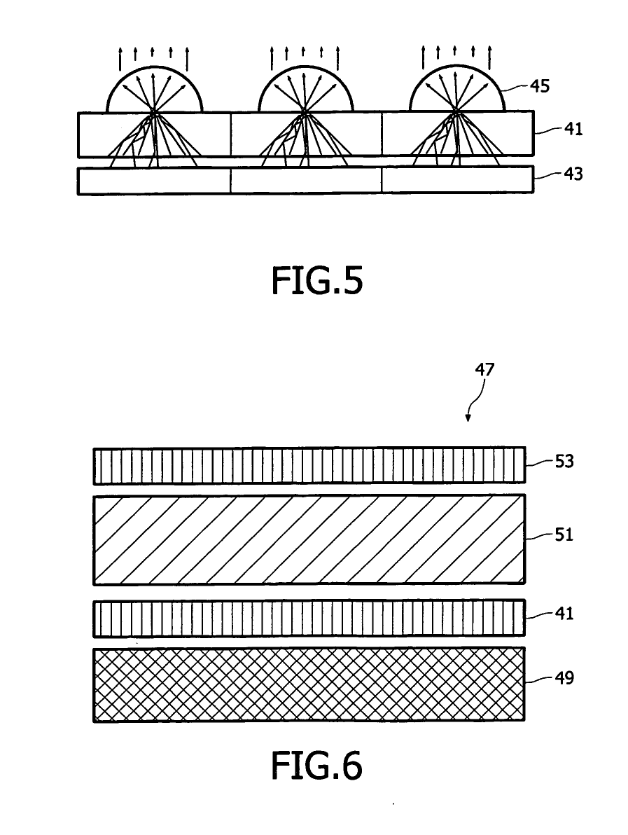

FIG. 5 shows in schematic form an array of the collimator panels shown in FIG. 3 for use in the backlight of a liquid crystal display device, together with a light source and lenses that make up the backlight;

FIG. 6 shows in schematic form a liquid crystal display device comprising the array shown in FIG. 5;

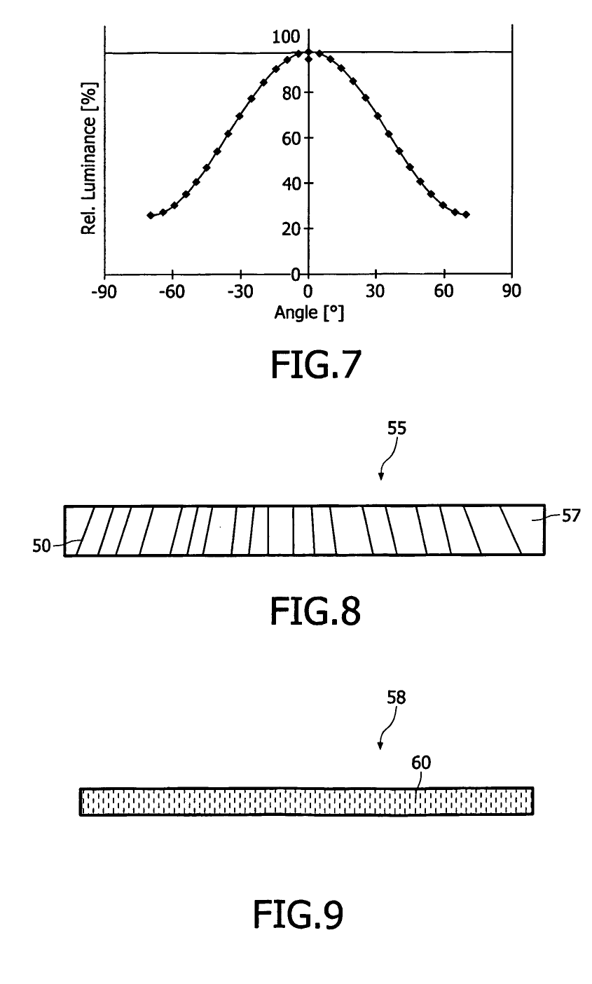

FIG. 7 is a graph showing how the luminance of the backlight shown in FIG. 5 varies with angle;

FIG. 8 shows in schematic form a second collimator panel according to the invention for use in collimating X-ray radiation;

FIG. 9 shows in schematic form a third collimator panel according to the invention for use in collimating visible light;

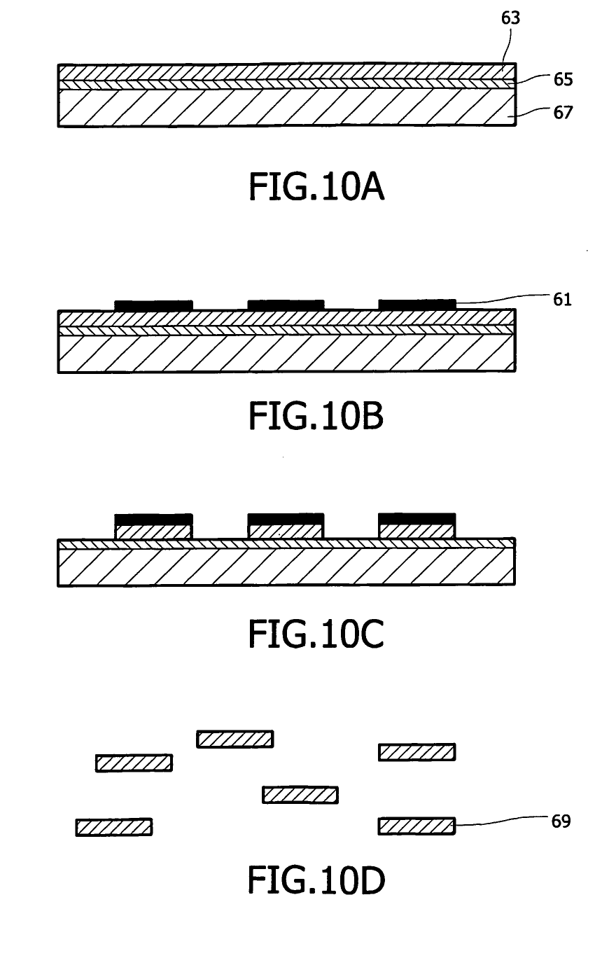

FIG. 10 shows in schematic form a first method of producing elongate particles for use in embodiments of the present invention;

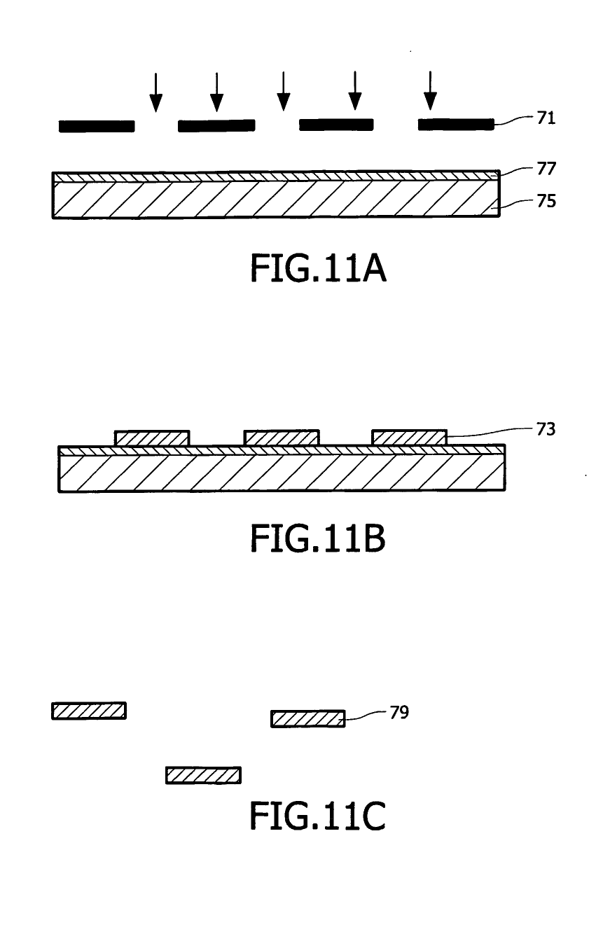

FIG. 11 shows in schematic form a second method of producing elongate particles for use in embodiments of the present invention;

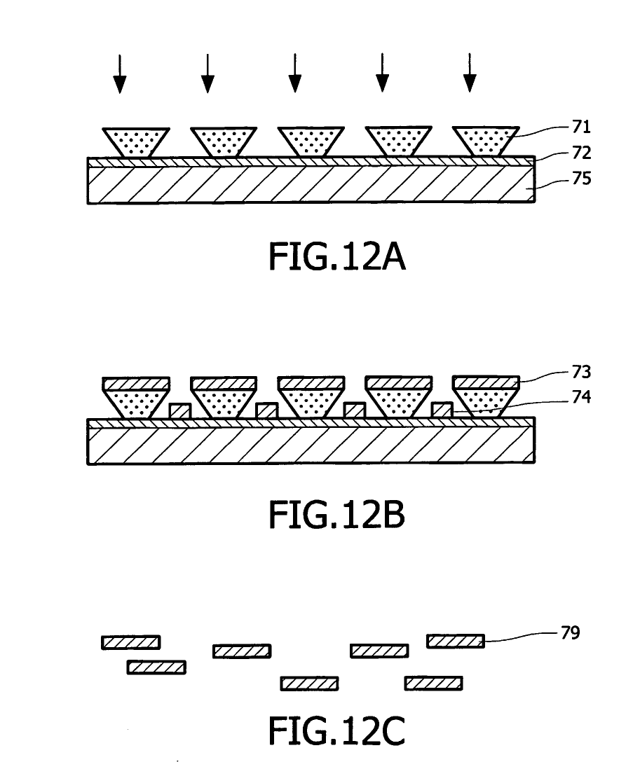

FIG. 12 shows in schematic form a third method of producing elongate particles for use in embodiments of the present invention;

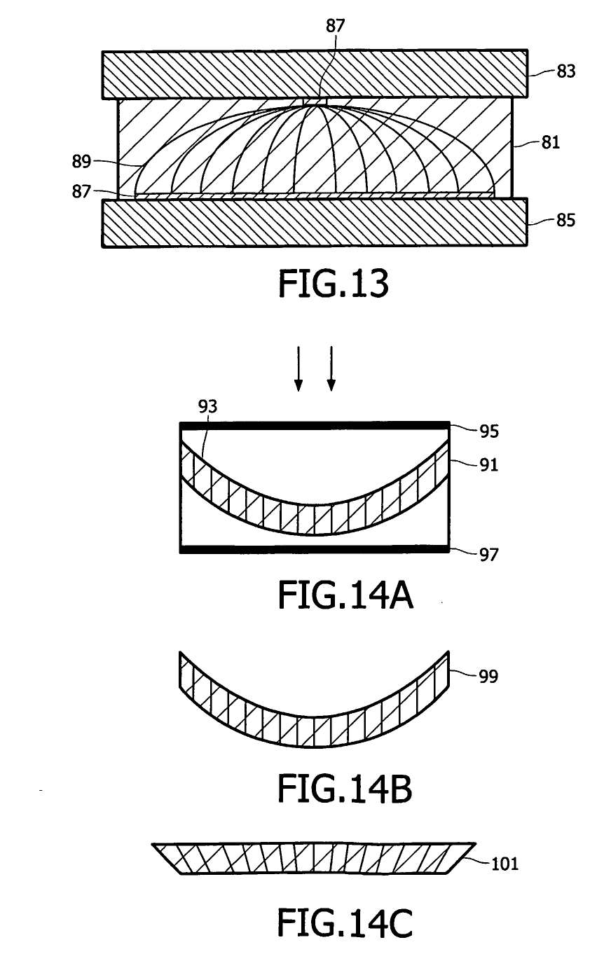

FIG. 13 shows in schematic form a first method of manufacturing a collimator panel according to the invention;

FIG. 14 shows in schematic form a second method of manufacturing a collimator panel according to the invention;

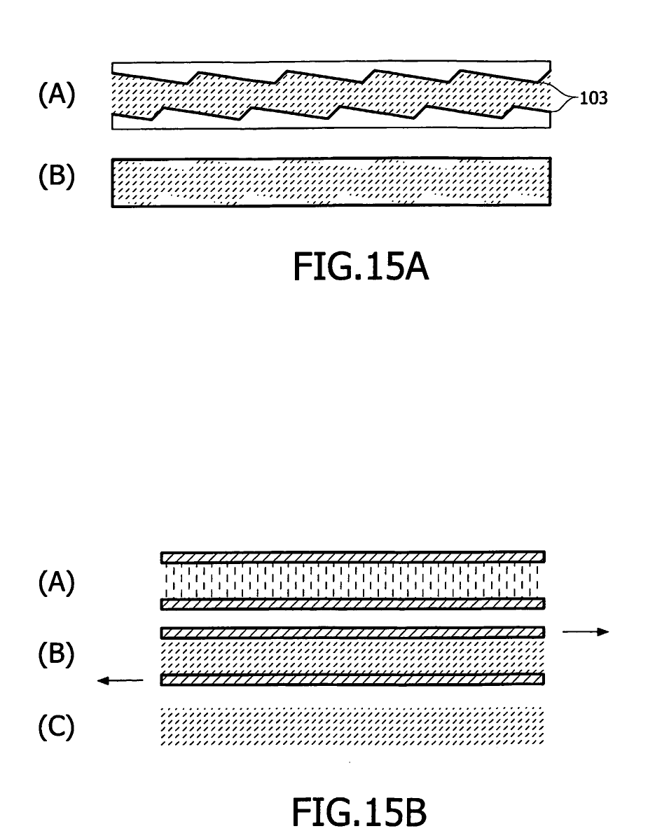

FIGS. 15A and 15B show in schematic form alternative methods of orientating suspensions of elongate particles; and

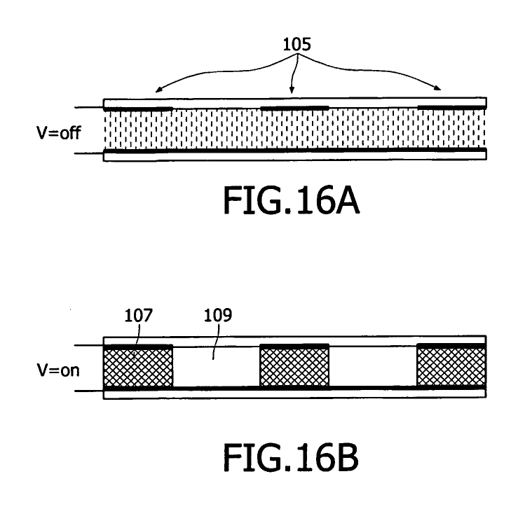

FIG. 16 shows in schematic form a method of producing super structures of elongate particles according to the invention.

FIG. 3 shows in schematic form a first collimator panel 33 according to the invention for use in collimating visible light.

The collimator panel 33 essentially comprises a transparent polymer sheet 35 in which elongate particles are suspended. The elongate particles are distributed throughout the polymer 35 and their longitudinal axes are orientated in a converging configuration. The orientation of the elongate particles is represented in the Figure by converging lines 37, which converge to a point at a fixed distance from the sheet 35. The elongate particles may alternatively be orientated so that different groups of particles have longitudinal axes which converge at different distances from the sheet 35.

The elongate particles suspended in the polymer sheet 35 are highly reflective aluminium particles that act as micro-sized mirrors. The aluminium particles have a mean thickness of 10 nm and a mean length and width of 10 μm.

The specific orientation of the particles provides a medium in which visible light may be very efficiently collimated. The suspended particles orientated in a converging configuration effectively provide converging light-guide structures that are narrower and more parallel than the inverse pyramid structures of the known collimator 1 shown in FIG. 1. These narrow, almost parallel light-guides eliminate reflection of light from the collimator panel back towards the light source. This is shown in FIG. 3 by the ray of light 39 being repeatedly reflected by the surfaces of the aligned particles as it passes through the polymer sheet 35. The ray of light 39 exits the polymer sheet 35 at an angle that is within a specific range that depends on the orientation and concentration of particles.

Comparison with the collimator 17 of FIG. 2 shows that the collimator 33 according to the invention is more efficient because more of the light is collimated and less of the light is reflected back towards the light source.

FIG. 4 shows a microscopic image of the collimator panel 33 according to the invention. It can be seen from FIG. 4 that the elongate particles (dark regions) are uniformly distributed throughout the polymer (light regions).

FIG. 5 shows in schematic form an array 41 of the collimator panels 33 shown in FIG. 3 for use in the backlight of a liquid crystal display device, together with a light source 43 and lenses 45. The array 41 may either comprise a plurality of separate collimator panels assembled together to form a single unit, or else may be a plurality of collimator panels integrated within a single polymer sheet, the sheet having more than one converging configuration of elongate particles.

The light source 43 produces rays of light that propagate in random directions. The randomly directed rays of light enter the collimator panels 33 and are guided by the elongate particles as they pass through the polymer panel. By the time the rays exit the panel, their angle to a normal is within a specific range. The rays of light then pass in to the lenses 45. The lenses 45 cause the exiting rays of light to become parallel rays of light.

FIG. 6 shows in schematic form a liquid crystal display device 47 comprising the array 41 shown in FIG. 5. The device comprises a light source 49, the array of collimator panels 41, the assembly 51 containing the liquid crystals themselves and, optionally, a diffuser panel 53.

FIG. 7 is a graph showing how the luminance of the backlight shown in FIG. 5 varies with angle. It can be seen from the Figure that the collimator panel causes the light to become highly collimated.

FIG. 8 shows in schematic form a second collimator panel 55 according to the invention for use in collimating X-ray radiation.

The collimator panel 55 essentially comprises a radiolucent polymer sheet 57 in which elongate particles are suspended. The elongate particles are distributed throughout the polymer 57 and their longitudinal axes are orientated in a converging configuration. The orientation of the elongate particles is represented in the Figure by converging lines 50 which converge to a point at a given distance from the sheet 57.

The elongate particles suspended in the polymer sheet 57 are lead particles that absorb X-ray radiation. The lead particles have a mean thickness of 1 μm and a mean length and width of 10 μm.

The specific orientation of the lead particles provides a medium in which X-rays may be effectively collimated. Rather than reflecting X-rays that are not propagating in the required angular direction, the lead particles absorb them. Only X-rays that enter the collimator panel 55 at required angular directions are transmitted.

When used with an X-ray point source and X-ray detector in a similar configuration to that shown in FIG. 2, the collimator panel 55 effectively absorbs scattered X-rays but also transmits X-rays travelling directly from the X-ray point source.

Compared to use of the known collimator 17 of FIG. 2, use of the collimator panel 55 according to the invention provides the X-ray detector with a higher quality image. In particular, the elongate lead particles cast a much less noticeable shadow on the detector. This is because the size and pitch of the elongate particles used in the collimator panel 55 are much smaller than the size and pitch of the lead foils used in the known collimator 17. Accordingly, the requirement for constant lateral movement of the collimator is eliminated, and the structure of X-ray detector apparatus may be simplified.

The use of elongate particles having a small size and pitch is possible because of their high aspect ratio, which enables high attenuation of scattered X-rays and minimal attenuation of X-rays travelling directly from the source, while at the same time casting a negligible shadow over the detector.

The collimator panel 55 provides a homogeneous gray scale over the whole area of the detector. This homogeneous gray scale is achieved by having homogeneous concentration of the elongate particles over the total area of the collimator panel 55.

The quality of orientation of the elongate particles can be improved by using inherently stiff particles to prevent folding and reduce potential sticking. Composite particles having lead attached to both sides of a rigid substrate may thus provide a suspension having improved orientation.

FIG. 9 shows in schematic form a third collimator panel according to the invention for use in collimating visible light.

The collimator panel 58 comprises a transparent polymer sheet 60 in which elongate particles are suspended. The elongate particles are distributed throughout the polymer 60 and their longitudinal axes are orientated in a parallel configuration. In this embodiment, the longitudinal axes of the particles are perpendicular to the surface of the polymer panel 60, but other arrangements are possible.

The surfaces of the elongate particles suspended in the polymer sheet 60 absorb visible light that is not travelling substantially parallel to the longitudinal axes of the elongate particles. In this way, the particles effectively collimate light that is incident on a surface of the collimator panel 58. The angular range of rays of light that are transmitted by the collimator panel 58 is dependent on the size and concentration of the particles suspended in the polymer sheet 60. The longer the particles, or the higher their concentration, the smaller the angular range of transmitted rays of light.

Suitable elongate particles include metal and dielectric particles such as particles made of aluminium oxide, silicon oxide coated with black pigments or organic dyes. Suitable particles also include particles made of pure dyes and pigments. Pure metals such as chromium or alloys and metal compounds such as silver sulfide are suitable materials for the particles, as are graphite or thin layers of carbon. Organic particles such as polymer particles containing pigments, dyes or smaller metallic particles are also suitable.

Such a collimator panel 58 may be placed on top of display devices to provide privacy for a user. For example, the collimator panel may be placed on top of the display device of an automated teller machine (ATM). Only the user observing the display from directly in front of the display is able to see the display images. Other persons observing the display at large angles to the normal are not able to see the display images.

In contrast to known privacy screens, screens according to the invention may also be two-dimensional, in which case the elongate particles will be arranged in a converging configuration.

The collimator panel shown in FIG. 9 comprises elongate particles having parallel longitudinal axes that are perpendicular to the surface of the collimator panel. However, in other embodiments of the invention, collimator panels may comprise elongate particles having parallel longitudinal axes that are at a constant angle, other than perpendicular, to the surface of the collimator panel. Such an arrangement is especially useful in applications where the surface of the collimator panel is at a non-perpendicular angle to a required observation direction.

For example, such a collimator panel may be incorporated into an angled windshield, or windscreen, of an automobile so as to allow the driver to observe the road ahead without being distracted by direct sunlight coming from vertically above. In this case the direct sunlight may be absorbed by elongate particles that absorb visible light. In alternative embodiments, the heating effect of direct sunlight may be avoided by employing a collimator panel having elongate particles that reflect visible and infrared light or only infrared light.

Methods of manufacturing a collimator according to the invention will now be described. Throughout this description, the term “electric field” is used to refer to a field that is used to orientate elongate particles within a liquid suspension. Electrodes of various forms are used to induce the electric field. However, the skilled reader will be aware that similar effects may be achieved using magnetic fields produced by permanent magnets. Accordingly, all such references to electric fields should be taken to include magnetic fields, when suitable for the particular types of particles.

Elongate, or flake-like, particles are first prepared. For some applications, particles having large variations in shape and size can be tolerated. Particles without good shape control and having a large distribution of sizes may be produced in several ways. One method is based on the evaporation of a thin layer on top of a substrate having a release coating, followed by its release and “milling” to small particle sizes. Other methods include the use of naturally occurring minerals such as mica, which can also be milled. Silicon and aluminium particles may also be produced in solution. However, as noted above, these particles have random shapes and dimensions.

For other applications, particles having a specific size, shape and/or surface property can result in a collimator having a higher performance. Accordingly, methods of preparing such particles are described.

FIG. 10 schematically shows a first method of producing elongate particles for use in embodiments of the present invention. This method may be performed using a variety of techniques such as offset printing, micro contact printing and inkjet printing. In all of these techniques, except for inkjet printing, a patterned surface or a surface to which ink has been transferred in a patterned way (a stamp) is used to transfer ink 61 to another surface comprising a layer to be patterned 63. The ink may be used as a positive or negative etch resist, depending on the type in ink. If it is used as a negative etch resist, material of the layer to be patterned 63 can be removed selectively by etching from those areas that are not covered or modified by the ink 61. If the ink is used as a positive etch resist, a second layer of ink providing a higher etch resistance is applied only to the so far unmodified areas of the surface (e.g. by deposition via self-assembly from solution). In this case, in the subsequent etching step, material is removed from those areas that had been modified with the first ink (the areas having the lower etch resistance). Other inking-etching schemes are also possible, including the local (patterned) chemical modification of the ink already deposited on the surface.

It is important that the layer to be patterned 63 contains a release layer 65 underneath (between the layer to be patterned 63 and a substrate 67). The release layer 65 can then be dissolved in a suitable solvent, decomposed by a suitable reagent solution, or removed by any other means to leave the free patterned structures 69 (particles, or flakes) as shown in FIG. 7. The ink 61 may or may not be removed by the solvent, the reagent solution or any other means applied to remove the release layer. If desired, the ink 61 may also be removed in another subsequent processing step.

It is also possible to use inkjet printing to produce the desired patterns. In that case the ink 61 can be deposited on top of the layer to be patterned 63 in the form of micro droplets. Further processing will be analogous to the above description. However, due to its sequential nature, the inkjet printing technique is generally slower.

Optical lithography may also be used to pattern a layer of photoresist material covering the layer to be patterned 63 using a photomask. After development of the resist layer, the layer to be patterned 63 may be etched and particles 69, or flakes, are produced in the same way as described above.

FIG. 11 schematically shows a second method of producing elongate particles for use in embodiments of the present invention. A mask 71 is used to deposit a layer of particles 73 onto a substrate 75 provided with a release layer 77. The release layer 77 is then dissolved, thus producing free particles, or flakes 79.

The mask 71 may also be manufactured on top of the substrate 75 as shown in FIG. 12. In this case, the particles 73 deposited on top of the mask 71 can be removed using a suitable solvent, thus providing free particles 79, while the material 74 deposited on an adhesion layer 72 is not removed. It is also possible to use an inverse technique where the deposited material adheres to the mask surfaces 71 and the material 74 deposited between the mask surfaces 71 is released.

The mask may also comprise a self-assembled monolayer printed on top of the release layer, thus providing modified areas with substantially different surface properties compared to unmodified areas. In the subsequent deposition step, material may then either be deposited in unmodified areas only, or may be deposited in all areas but be easier to remove from modified areas due to substantially weaker adhesion properties.

The elongate particles, or flakes, may comprise a single layer or several layers of material. The material may be metallic, organic or inorganic. For example, the flakes may comprise a layered dielectric material reflecting a certain band of light. They may alternatively consist of two different layers having different physical (e.g. optical) or chemical surface properties. In a dual layer configuration, one of the layers may be absorbing and the other layer reflecting. It is also possible to combine layers that react with different molecules in different ways. For example, one of the surfaces may be chosen so that it specifically reacts with a polar molecule while the other surface may have a high reactivity with an apolar substance. In this way, particles with specific polar and apolar surfaces can be produced.

The particles, or flakes, may also be surface modified. For example, modification of the two surfaces of a particle having polar and apolar groups, respectively.

Reactive groups may also be attached to the surfaces of particles. Particles having reactive groups may be co-polymerised in a solution containing other reactive molecules and made to become part of a polymeric chain. In this way, stable suspensions of particles can be produced.

FIG. 13 shows in schematic form a first method of manufacturing a collimator panel according to the invention. Referring to FIG. 13, in order to manufacture a collimator panel, elongate particles prepared by one of the methods described above are suspended in a polymerisable liquid. In this example, the particles are aluminium flakes, but other materials are suitable. The aluminium flakes have a mean thickness of 10 nm and length of 9 to 11 μm, and the polymerisable liquid comprises polyethyleneglycol (400) diacrylate. The aluminium flakes 81 are added to the polymerisable liquid at a concentration by weight of 0.025%. The flakes may be uniformly distributed within the liquid by physically mixing the suspension.

Once the aluminium flakes are evenly distributed, the suspension 81 is brought between two ITO (Indium tin oxide) electrode coated transparent glass substrates 83, 85. The glass substrates 83, 85 are held apart by a fixed distance and are parallel. Next, an electric field is induced across the suspension by applying a voltage to electrodes. The electric field is induced so that field lines 89 run in a specific converging pattern corresponding to the required alignment of the elongate particles. Patterns of ITO electrodes that are capable of producing converging field lines will be known to those skilled in the art, and one such pattern 87 is shown in the Figure by way of example. Depending on the complex dielectric constants of the materials present in an electric field, the direction and density of the field lines may be influenced. Thus in order to direct the electric field lines 89 in an optimal manner, pre-formed polymeric structures may be employed.

The electric field causes the longitudinal axes of the suspended elongate particles to gradually become oriented along the electric field lines.

Once all of the suspended particles have become orientated by the electric field, polymerisation is initiated in order to “freeze in” the orientation of the particles. Polymerisation is initiated by exposing the suspension 81 to ultraviolet (UV) light, for example, for one minute at approximately 1 mW/cm².

Once polymerisation is complete, the ITO coated glass substrates 83, 85 are removed and a flat flexible transparent film having suspended orientated particles remains. This film is the collimator panel according to the present invention.

The converging configuration of the particles provides a medium capable of collimating visible light in a converging or diverging manner, depending upon which side of the collimator panel the light is incident.

FIG. 14 shows in schematic form a second method of manufacturing a collimator panel according to the invention. This second method is similar to the first method described above, except that the converging configuration of the elongate particles is achieved by a different technique involving an additional step. Again, elongate particles prepared by one of the methods described previously are suspended in a polymerisable liquid. In this example, the particles are lead flakes, but other materials are suitable. For example, the particles may comprise polymeric particles each filled with X-ray absorbing metallic or organic material. The lead particles are added to the polymerisable liquid at a concentration by volume of 5%. The concentration of lead particles may be adjusted, depending on the absorption required for the specific application. The flakes may be uniformly distributed within the liquid by physically mixing the suspension.

Once the lead flakes are evenly distributed, the suspension 91 is placed in a contoured mould 93, as shown in “A”. The no-flat mould 93 has a surface relief, which in this example is convex. The mould is brought between two electrodes 95, 97, which in this case are ITO electrodes coated onto transparent substrates. Next, an electric field is induced across the suspension 91 by applying a voltage to the electrodes 95, 97. The electric field is induced so that the field lines are parallel and run perpendicular to the electrode surfaces.

The electric field causes the longitudinal axes of the suspended elongate particles to gradually become oriented along the field lines.

Once all of the suspended particles have become orientated by the electric field, polymerisation is initiated in order to “freeze in” the orientation of the particles. Polymerisation is initiated by exposing the suspension 91 to ultraviolet (UV) light, for example, for one minute at approximately 1 mW/cm².

Once polymerisation is complete, the ITO electrodes 95, 97 are removed and a flexible transparent convex film 99 having suspended orientated particles remains, as shown in “B”.

The convex film is flattened out, either by clamping it between rigid flat substrates, or else by stretching it from its edges. This flattened film 101, as shown in “C”, is the collimator panel according to the present invention.

The converging orientation of the particles provides a medium capable of collimating X-rays in a converging or diverging manner, depending upon which side of the collimator panel the X-ray radiation is incident.

FIGS. 15A and 15B show in schematic form alternative techniques for orientating suspensions of elongate particles. In both of these methods, a collimator panel having parallel elongate particles orientated at a non-perpendicular angle to the surface of the panel is provided.

FIG. 15A illustrates the use of faceted electrodes 103 to achieve elongate particles having longitudinal axes that are parallel and at an angle of approximately 45° to the surface of the collimator panel (“A”). In this case, the solidified liquid film is mounted between substrates to provide the collimator panel (“B”). The substrates induce no distortion of the solidified liquid film and thus the parallel and angled orientation of the particles is preserved.

FIG. 15B illustrates the use of a shearing force applied to the respective surfaces of the collimator panel (“B”). This shearing force causes the collimator panel to distort and the parallel elongate particles move from perpendicular orientations to non-perpendicular orientations. The shearing force may be applied before, during or after the liquid holding the suspension of particles is solidified.

FIG. 16 shows in schematic form a method of producing super structures of elongate particles according to the invention. According to the method, a patterned electrode 105 is used so that, when an electric field is applied to a suspension of elongate particles, particles migrate to provide specific regions having a high density of particles 107 and specific regions having a low density of particles 109. The regions having a high density of particles 107 form super structures. For example, in FIG. 16, super structures each having a depth of approximately 40 μm are separated by empty regions each having a depth of approximately 200 μm. The thickness of the collimator panel is 2 mm so that it provides parallel collimation.

It is to be understood that this detailed description discloses specific embodiments of a broader invention and is not intended to be limiting. There are many other embodiments within the scope of the invention as claimed hereafter, and these will be apparent to those skilled in the art.

For example, the methods of manufacturing a collimator panel have been described as involving use of parallel or shaped electric field lines, a shaped mould, faceted electrodes and a shear force. However, a combination of these techniques may be used b provide a collimator panel in which a desired orientation of the suspended particles is accurately achieved.

Further, a simple collimator panel having elongate particles whose longitudinal axes are parallel may be manufactured between flat parallel substrates using a parallel electric field. Such a collimator panel is shown in FIG. 9.

The embodiments of the invention that have been described above all comprise elongate particles made from various different materials. The elongate particles may also be made from magnetic materials, in which case a magnetic field may be used to induce a specific orientation of the particles.

1. A collimator (33, 55, 58) panel comprising:
a solid panel (35, 57, 60) having a first face for receiving uncollimated radiation and a second opposite face for providing collimated radiation; and
a plurality of elongate particles (37, 50) disposed in the panel and orientated to provide the collimating function.

2. The collimator panel of claim 1, wherein the longitudinal axes of the particles are orientated in a parallel configuration.

3. The collimator panel of claim 2, wherein the particles absorb visible light.

4. The collimator panel of claim 2, wherein the particles reflect visible and infrared light.

5. The collimator panel of claim 1, wherein the longitudinal axes of the particles are orientated in a converging configuration.

6. The collimator panel of claim 5, wherein the longitudinal axes of the particles converge to a point at a fixed distance from the collimator plate.

7. The collimator panel of claim 5, wherein the longitudinal axes of different groups of particles converge at points at different distances from the collimator plate.

8. The collimator panel of claim 5, wherein the surfaces of the particles reflect visible light.

9. The collimator panel of claim 8, wherein the particles are metallic particles or dielectric multi-layer particles.

10. The collimator panel of claim 1, wherein the solid panel is translucent.

11. The collimator panel of claim 5, wherein the particles absorb X-ray radiation.

12. The collimator panel of claim 11, wherein the particles are lead particles, lead alloy particles or tungsten particles.

13. The collimator panel of claim 11, wherein the solid panel is radiolucent.

14. The collimator panel of claim 1, wherein the ratio between thickness and length of the particles is at least 1:10.

15. The collimator panel of claim 1, wherein the thickness of the particles is in the range 5 nm to 1 μm and the length of the particles is in the range 1 μm to 100 μm.

16. The collimator panel of claim 1, wherein the solid panel comprises a cured polymerisable liquid.

17. The collimator panel of claim 1, wherein the solid panel comprises an organic material having a solidifying temperature above 40° C.

18. A display device comprising the collimator panel of claim 2.

19. A backlight (41, 49) for a transmissive liquid crystal display device (47) comprising the collimator panel of claim 8.

20. An X-ray detector comprising the collimator panel of claim 11.

21. A collimator panel array (41) comprising a plurality of collimator panels according to claim 1.

22. A method of manufacturing a collimator panel, the method comprising the steps of:
suspending a plurality of elongate particles in a liquid;
applying an electric or magnetic field to the suspension to orientate the particles; and
solidifying the liquid to fix the orientation of the particles, thereby forming a collimator panel.

23. The method of claim 22, further comprising the step of bringing the suspension between contoured surfaces (93) prior to the step of applying an electric or magnetic field.

24. The method of claim 23, further comprising the step of flattening the collimator panel after the step of solidifying the liquid.

25. The method of claims 22, further comprising the step of bringing the suspension between flat parallel surfaces prior to the step of applying an electric or magnetic field.

26. The method of claim 22, wherein the step of applying an electric or magnetic field comprises applying an electric or magnetic field having parallel field lines.

27. The method of claim 22, wherein the step of applying an electric or magnetic field comprises applying an electric or magnetic field having non-parallel field lines.

28. The method of claim 22, wherein the liquid comprises a polymerisable liquid, and the step of solidifying the liquid comprises polymerising the liquid.

29. The method of claim 22, wherein the liquid comprises an organic material having a solidifying temperature above 40° C., and the step of solidifying the liquid comprises cooling the liquid.

30. The method of claim 28, wherein the step of polymerising the liquid comprises exposing the liquid to ultraviolet light to initiate a polymerisation reaction.

31. The method of claim 28, wherein the polymerisable liquid comprises a (metha)acrylate, an epoxy, a vinylether monomer or a thiolene system.

32. A method of manufacturing elongate particles (69) for suspending in panels, the method comprising the steps of:
depositing a patterned layer of negative etch resist material (61) on a layer of elongate particle material (63), patterned areas representing a required shape and size of a plurality of elongate particles (69); and
etching areas of the layer of elongate particle material not covered by the negative etch resist material, thereby leaving elongate particles.

33. The method of claim 32, wherein the layer of elongate particle material is disposed on a substrate (67) coated with a release layer (65), and wherein the method further comprises, after the step of etching, the step of releasing the elongate particles from the substrate.

34. The method of claim 33, wherein the step of releasing the elongate particles from the substrate comprises dissolving the release layer in a solvent.

35. The method of claim 32, further comprising, after the step of etching, the step of removing the negative etch resist material from the elongate particle material.

36. The method of claim 32, wherein the patterned layer of negative etch resist material is deposited by offset printing, microcontact printing or inkjet printing.

37. A method of manufacturing elongate particles for suspending in panels, the method comprising the steps of:
depositing a patterned layer of positive etch resist material on a layer of elongate particle material, unpatterned areas representing a required shape and size of a plurality of elongate particles;
processing the unpatterned areas to make them more etch resistant than the patterned areas; and
removing the positive etch resist material and etching areas of the layer of elongate particle material that were covered by the positive etch resist material, thereby leaving elongate particles.

38. The method of claim 37, wherein the layer of elongate particle material is disposed on a substrate coated with a release layer, and wherein the method further comprises, after the step of removing the positive etch resist material and etching, the step of releasing the elongate particles from the substrate.

39. The method of claim 38, wherein the step of releasing the elongate particles from the substrate comprises dissolving the release layer in a solvent.

40. The method of claim 37, wherein the patterned layer of positive etch resist material is deposited by offset printing, microcontact printing or inkjet printing.

41. The method of claim 22, preceded by the method of manufacturing elongate particles for suspending in panels, the method comprising the steps of:
depositing a patterned layer of positive etch resist material on a layer of elongate particle material, unpatterned areas representing a required shape and size of a plurality of elongate particles;
processing the unpatterned areas to make them more etch resistant than the patterned areas; and
removing the positive etch resist material and etching areas of the layer of elongate particle material that were covered by the positive etch resist material, thereby leaving elongate particles.
